(19) United States
(12) Patent Application Publication
(10) Pub. No.: US 2016/0081352 A1
(43) Pub. Date: Mar. 24, 2016

(54) Pest control formulation of Neem and Beauveria bassiana and methods of making and using same

(71) Applicant: Luis Augusto Mazariegos, Pembroke Pines, FL (US)

(72) Inventor: Luis Augusto Mazariegos, Pembroke Pines, FL (US)

(21) Appl. No.: 14/494,199

(22) Filed: Sep. 23, 2014

(51) Int. Cl. A01N 65/00; A01N 25/30; A01N 25/02; A01N 65/26

(52) U.S. Cl. CPC A01N 65/00; A01N 65/26; A01N 25/30; A01N 25/02

(57) ABSTRACT

The present invention describes a pesticidal compositions containing a pesticidal natural oil, Neem, and a pesticidal natural fungal entomopathogen, Beauveria bassiana. These compositions can be used to control pests by killing the pests, preventing or reducing feeding, preventing or reducing eclosion of their eggs. These compositions exhibit effective or more rapid knockdown pesticidal activity, and synergistic pesticidal activity. These compositions can be used to control pests including insects and/or arachnids, including arthropods such as whiteflies.

### TECHNICAL FIELD

Some embodiments of the present invention pertain to compositions that can be used to control a variety of pests. Some embodiments of the present invention can be used to control arthropods, including insects and arachnids, and/or other pests. Some embodiments of the present invention can be used to control sucking and biting pests, including e.g. whiteflies, aphids, thrips, mites, mosquitoes, ticks, lice, stink bugs, flies, cockroaches and moths. Some embodiments of the invention pertain to methods of using compositions to control pests. Other embodiments of the invention pertain to methods of making compositions to control pests.

### BACKGROUND

Pest control is an ongoing, worldwide problem. In addition to physical means of control that have been practiced for centuries, recent decades have witnessed the emergence and widespread use of hundreds of chemically developed pest repellents, growth regulators, and insecticides. These products are frequently synthetic varieties that are heavily refined prior to commercialization—the list includes the pyrethroids (including deltamethrins, cyfluthryns, etc), DEET and other aromatic amides, organophosphates, and carbamates. The usefulness of these products is often limited by factors including human or environmental toxicity, insect resistance (particularly to pyrethroids; see e.g. Romero, et al.). For these reasons and due to shifting consumer preference paradigms, there is consistently increasing demand for naturally-derived, effective pest control products that overcome these limitations.

Some pesticide products are derived from botanical and other natural sources; for example the pyrethrin classes of pesticides are derived from the pyrethrum daisy, Chrysanthemum cinerariaefolium. Other examples include: rotenone, from the roots of Derris lonchocatpus; ryania, from the stems of Ryania speciosa; and neem, derived from the leaves, bark, and seeds of Azadirachta indica.

The tree Azadirachta indica—in some cases referred to as the “Sacred Tree” or “Nature's Pharmacy”—has long been recognized as a source of a wide variety of useful bioactive compounds. Neem derivatives have demonstrated effectiveness as moisturizing agents, and neem oil itself has been used as a treatment for various skin conditions including acne, psoriasis, and chicken pox. It is also used in toothpastes, as a cooking ingredient, and in pharmaceuticals for treating a range of symptoms including fever, earache, headache, and serious disorders including diabetes (see e.g. Brachmachari). In the agricultural sector, neem oil is considered an effective measure for the prevention of mildew, anthracnose, rust, leaf spot, botrytis, scab and alternaria. Its derivatives have furthermore been described variously as antiviral, antimicrobial, antifungal, and antiseptic. Neem oil and many of its derivatives have also been recognized and used as insect control agents and pesticides.

Neem oil contains dozens of active compounds that kill or repel insects, with demonstrated efficacy against more than 375 insect species. It has been recognized as a repellent of many pests, particularly insects (see e.g. Mishra, et al).

Current hypotheses suggest that neem oil may work as a contact killer, as an antifeedant, as an insect-growth regulator, a sterilizing agent, a gut motility inhibitor, and/or as a chitin inhibitor. Azadirachtin—an important active ingredient in neem oil—has been reported to exhibit antifeedant, repellent, and sterilization activities under certain circumstances and has been used as a pest control chemical in the past (see U.S. Pat. No. 4,556,562).

Neem oil and azadirachtin are believed to exhibit complex mechanisms of insect toxicity, including activity upon insect hormonal systems, antifeedant activity, anti-molting activity, and numerous other activities. Neem oil as a pesticide is biodegradable and of low environmental and human toxicity, exempted from the tolerance requirement by the United States EPA (see United States Federal Register, Volume 60, Number 239, 1995).

Neem oil has drawbacks as an insecticide. While effective at preventing molting and exhibiting certain repellency characteristics in some insects, reports of neem oil's knockdown capability are inconsistent (see e.g. Schumutter), and some studies find it less efficient at killing adult insects than related pesticides (see Pavela).

There remains a need for improved pesticides derived from natural sources, pesticides that can prevent egg eclosion, and pesticides having improved synergistic pesticidal activity.

Several Beauveria bassiana isolates have shown variable compatibility with neem based products. In a study which included 30 isolates of B. bassiana from culture collections was screened for compatibility with a commercial formulation of neem oil at the field recommended dose (0.3%, v/v) (see e.g. Mohan, et al). Compatibility was tested in vitro through germination and growth assays. In all isolates, conidial germination was delayed but not significantly decreased by neem. In the growth assays, 23 isolates were found compatible with neem. In the neem sensitive isolates, growth was decreased but not totally inhibited. The effect of combined treatment with B. bassiana and neem in comparison to single treatments with either of them on Spodoptera litura was tested in laboratory bioassays. The combined treatment was found to have synergistic effect on insect mortality when a B. bassiana isolate compatible with neem was used, while, with an isolate sensitive to neem, an antagonistic effect was observed.

Furthermore, a study on the compatibility of the entomopathogenic fungus Beauveria bassiana with neem was conducted against sweetpotato whitefly, Bemisia tabaci, on eggplant (see e.g. Islam et al). Initially, three concentrations of neem (0.25%, 0.5% and 1.0%) were used to investigate the physiological responses of B. bassiana. Thereafter, above three concentrations of neem along with three concentrations of B. bassiana (10⁶, 10⁷and 10⁸ conidia/ml) were used to investigate combined deterrence index, DI under two application methods (foliar and soil) of B. tabaci. Significant differences were observed among neem concentrations on all variables—germination percentage, vegetative growth, number of conidia, amount of biomass and proteolytic activity of B. bassiana. The reduction percentage of germination, vegetative growth, sporulation, biomass production and proteolytic activity of B. bassiana were as high as 12%, 13%, 35%, 38%, and 34%, respectively, to neem. Significant differences were also observed on deterrence index, DI (adult and oviposition) of B. tabaci. The current study investigated that the highest adult DI (80.15) and oviposition DI (88.25) occurred when 1.0% neem was combined with 10⁸ conidia/ml of B. bassiana. As the results show, neem is compatible with B. bassiana.

The Beauveria bassiana GHA strain has been shown to be compatible with neem (see e.g. Al-mazra'awi et al). The combined effect of the entomopathogen B. bassiana strain GHA and a neem product that contains 0.15% (1500 ppm per liter) azadirachtin has been evaluated against the onion thrips Thrips tabaci by two application approaches on potted tomato plants in a greenhouse. The first approach was a topical application of a mixture of the two control agents, 1.75×10⁸ conidia per ml and then adding neem to the suspension at a field rate of 5 ml per liter. While the second was a topical application of B. bassiana GHA strain and a drenching application of neem was drenched to the tomato plants at a rate of 25 ml per liter. In the mixture application, onion thrips adults treated with B. bassiana GHA strain and sub-lethal doses of neem tree extracts exhibited greater mortalities than insects treated with the fungus alone but with no synergistic interaction. However, the two control agents interacted antagonistically when neem tree extract was used at full field application rate. Chi-square tests showed that the two control agents interacted synergistically when B. bassiana GHA strain was used at full field rate with neem at 0.1 times and 0.5 times the field application rate with the later resulting in the highest mortality. High mortality of 70% was also achieved when the combination of both control agents at full field rate but with an additive interaction. Topical application of B. bassiana GHA strain and drenching application with sub-lethal doses of the rational insecticide neem increased the mortality of onion thrips more than using each control agent alone or mixing them together.

The fungal isolate Beauveria bassiana GHA strain has been used for almost 20 years in commercial products for control of an important number of pest in agriculture. The liquid formulations of GHA strain based products have a spore concentration of 2×10¹⁰ spores per ml.

### SUMMARY

Some embodiments of the present invention provide pesticidal compositions containing a pesticidal natural oil and/or a component thereof and/or a derivative thereof and a pesticidal natural fungal entomopathogen. Some embodiments can be used to control pests by killing the pests, preventing or reducing feeding, preventing or reducing eclosion of their eggs, or the like. Some embodiments exhibit effective or more rapid knockdown pesticidal activity, and synergistic pesticidal activity. Some embodiments can be used to control pests including insects and/or arachnids, including arthropods such as whiteflies.

In some embodiments, the pesticidal natural oil is neem oil. In some embodiments, the pesticidal natural fungal entomopathogen is selected from the group consisting of: Aschersonia spp. Beauveria spp., Entomophthora spp., Hirsutella spp., Isaria spp., Lecanicillium spp., Metarhizium spp. Nomuraea spp., and Paecilomyces spp. In some embodiments, the pesticidal natural fungal entomopathogen is a Beauveria bassiana. In some embodiments, the pesticidal natural oil is neem oil and the pesticidal natural fungal entomopathogen is Beauveria bassiana strain GHA.

In some embodiments, the combination of the natural pesticidal oil and the pesticidal natural fungal entomopathogen exhibits a synergistic level of pesticidal activity. In some embodiments, the combination of the pesticidal natural oil and the pesticidal natural fungal entomopathogen is effective as a pesticide wherein each of the pesticidal natural oil and pesticidal natural fungal entomopathogen are present at a concentration below the concentration at which the pesticidal natural oil or the pesticidal natural fungal entomopathogen would exhibit similar pesticidal activity if used alone. In some such embodiments, the pesticidal natural fungal entomopathogen is Beauveria bassiana strain GHA and the pesticidal natural oil is neem oil.

### BRIEF DESCRIPTION

Compositions useful for controlling pests are disclosed. In some embodiments, the composition includes a pesticidal natural fungal entomopathogen and a pesticidal natural oil. Methods of making and using the compositions are disclosed.

### BRIEF DESCRIPTION OF THE DRAWINGS

FIG. 1 shows the results of an example testing the prevention of egg emergence composition in accordance with one embodiment of the invention.

FIG. 2 shows the results of an example testing the ability of a composition in accordance with one embodiment of the invention to kill aphids.

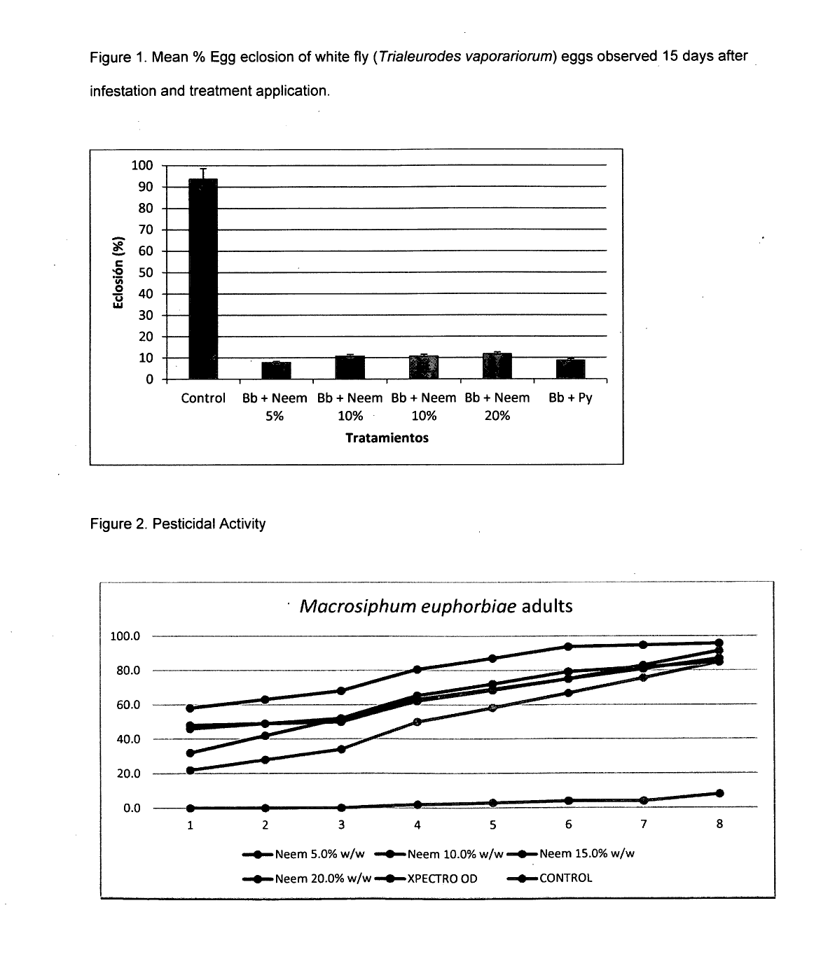

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Where a range of values is provided, it is understood that each intervening value, to the tenth of the unit of the lower limit unless the context clearly dictates otherwise, between the upper and lower limit of that range and any other stated or intervening value within that stated range is encompassed within embodiments of the invention. The upper and lower limits of these smaller ranges may independently define a smaller range of values, and it is to be understood that these smaller ranges are intended to be encompassed within embodiments of the invention, subject to any specifically excluded limit in the stated range.

Unless defined otherwise, all technical and scientific terms used herein have the same meaning as commonly understood by one of ordinary skill in the art to which this invention belongs. Although any methods and materials similar or equivalent to those described herein can also be used in the practice or testing of embodiments of the present invention, preferred methods and materials are described to avoid unnecessarily obscuring the disclosure.

As used herein, “comprises” or “comprising” are to be interpreted in their open-ended sense, i.e. as specifying that the stated features, elements, steps or components referred to are present, but not excluding the presence or addition of further features, elements, steps or components.

As used herein, singular forms include plural references unless the context clearly dictates otherwise. For example, “a fungus” also encompasses “fungi”.

As used herein, the term “pest” refers to organisms that negatively affect a host—such as a plant or an animal such as a mammal—by colonizing, damaging, attacking, competing with them for nutrients, or infecting them. This includes arthropods including insects and arachnids, and includes sucking and biting pests such as bed bugs, mites, ticks, ants, lice, and cockroaches.

As used herein, the term “pesticide” refers to an agent that can be used to control and/or kill a pest. The term is understood to encompass, but is not limited to, naturally occurring or synthetic chemical insecticides (larvicides, adulticides, ovicides), acaricides (miticides), fungicides, nematicides, parasiticides, or other control agents. “Pesticidal activity” refers to an agent that is active as a pesticide.

As used herein, the term “egg emergence” means eclosion; that is, the emergence of an adult insect from its pupal case or the hatching of an insect larva/nymph from an egg. “Preventing eclosion” or “preventing egg emergence” means preventing or delaying the emergence of an adult insect from its pupal case or the hatching of an insect larva from an egg.

As used herein, the terms “control” or “controlling” are meant to include, but are not limited to, any killing, growth regulating, or pestistatic (inhibiting or otherwise interfering with the normal life cycle of the pest) activities of a composition against a given pest. These terms include for example sterilizing activities which prevent the production of ova or sperm, cause death of sperm or ova, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, reducing gut motility, inhibiting the formation of chitin, disrupting mating or sexual communication, and preventing feeding (antifeedant) activity.

As used herein, a “pesticidal natural oil” is a natural oil or oils, for example derived from plant material, that exhibits pesticidal activity on its own. As used herein, “pesticidal natural oil” includes other materials derived, extracted or otherwise obtained from natural sources, for example, powdered extracts and the like. A “derivative” is a compound or composition that can be obtained from a natural oil. A “constituent” or “component” is a compound or composition found in a natural oil.

As used herein, “neem oil” refers to oil derived from the seeds, leaves, and bark of Azadirachta indica. Methods for obtaining neem oil, azadirachtin extract or other derivatives purified from neem oil are known in the art. One exemplary method for obtaining neem oil is cold pressing.

As used herein, “knockdown” activity refers to the pesticidal activity of a composition as applied directly to a pest.

As used herein, “surface” or “target surface” includes a surface to which a pesticide is applied or is to be applied. Such surfaces may include, for example, a surface where pests are likely to contact or otherwise be exposed to the applied pesticide, to lay their eggs, and/or a surface that has been or is suspected to be infested by pests.

As used herein, the term “stability” means the ability of a composition to retain its pesticidal activity after application to a surface to be treated with insecticide.

The term “carrier” as used herein refers to an inert material, organic or inorganic, with which an active ingredient can be mixed or formulated to facilitate its application, storage, transport, and/or handling. Commonly used carriers include, but are not limited to, mineral oil and vegetable oil. Exemplary carriers that can be used in some embodiments of the invention include inert carriers listed by the U.S. EPA as a Minimal Risk Inert Pesticide Ingredients (4A), Inert Pesticide Ingredients (4B) or under EPA regulation 40 CFR 180.950, each of which is hereby incorporated herein by reference in its entirety for all purposes.

Some embodiments of the present invention provide compositions and methods useful in the control of a variety of pests. Some embodiments of the present invention can be used to control insects, arachnids, and/or other pests. Some embodiments of the present invention can be used to control sucking and biting pests, including e.g. whiteflies, aphids, thrips, mites, mosquitoes, ticks, lice, fleas, stink bugs, flies, cockroaches, spiders and/or moths.

In some embodiments, the composition includes a combination of a pesticidal natural oil and a pesticidal natural fungal entomopathogen. In some embodiments, the combination of the pesticidal natural oil and the pesticidal natural fungal entomopathogen is effective to control pests. In some embodiments, the combination of the pesticidal natural oil and the pesticidal natural fungal entomopathogen is effective to prevent eclosion. In some embodiments, the combination of the pesticidal natural oil and the pesticidal natural fungal entomopathogen exhibits effective knockdown pesticidal activity. In some embodiments, the combination of the pesticidal natural oil and the pesticidal natural fungal entomopathogen exhibits synergistic pesticidal activity.

In some embodiments, the combination of the pesticidal natural oil and the pesticidal natural fungal entomopathogen exhibits markedly improved ability to control pests and/or an expanded range of pesticidal activity as compared with either the pesticidal natural oil or the pesticidal natural fungal entomopathogen alone. In some embodiments, a composition including a combination of a pesticidal natural oil and a pesticidal natural fungal entomopathogen acts to prevent eclosion when used under conditions at which the pesticidal natural oil or the pesticidal natural fungal entomopathogen used alone would not prevent eclosion to a significant level. In some embodiments, a composition including a combination of a pesticidal natural oil and a pesticidal natural fungal entomopathogen exhibits improved or more rapid knockdown of a pest as compared with either the pesticidal natural oil or the pesticidal natural fungal entomopathogen used alone. In some embodiments, a composition including a combination of a pesticidal natural oil and a pesticidal natural fungal entomopathogen exhibits synergistic pesticidal activity as compared with either the pesticidal natural oil or the pesticidal natural fungal entomopathogen used alone.

In some embodiments, compositions including a pesticidal natural oil and a pesticidal natural fungal entomopathogen prevent egg emergence (i.e. prevent eclosion). In some embodiments, compositions including a pesticidal natural oil and a pesticidal natural fungal entomopathogen exhibit prolonged egg eclosion prevention activity.

In some embodiments, a composition including a combination of a pesticidal natural oil and pesticidal natural fungal entomopathogen exhibits improved or more rapid knockdown of pests as compared with either the pesticidal natural oil or pesticidal natural fungal entomopathogen alone.

In some embodiments, compositions including a pesticidal natural oil and a pesticidal natural fungal entomopathogen exhibit both improved or more rapid knockdown of pests as compared with either the pesticidal natural oil or the pesticidal natural fungal entomopathogen used alone.

In some embodiments, the pesticidal natural oil is neem oil or a component or derivative thereof. In other embodiments, the pesticidal natural oil is any oil having as a constituent one of the following compounds, or a combination of the following compounds: azadirachtin, nimbin, nimbinin and salannin.

Derivatives and/or components of neem oil that can be used in embodiments of the present invention include, but are not limited to, neem oil, azadirachtin, nimbin, nimbolide, nimbolinin, salannin, nimbandiol, nimbinene, nimbocinone, limocinol, limocinone, nimolinone, azadirachnol, or other triterpenoids, azadirone, azadiradione, azadirachtol, epoxyazadiradione, other compounds derived from neem, related to neem, combinations thereof, and their active derivatives.

In some embodiments, a surfactant is used in preparing pesticidal compositions or pest control agents. Suitable surfactants can be selected by one skilled in the art. Examples of surfactants that can be used in some embodiments of the present invention include, but are not limited to, sodium lauryl sulfate, saponin, ethoxylated alcohols, ethoxylated fatty esters, alkoxylated glycols, ethoxylated fatty acids, carboxylated alcohols, carboxylic acids, fatty acids, ethoxlylated alkylphenols, fatty esters, sodium dodecylsulfide, other fatty acid-based surfactants, other natural or synthetic surfactants, and combinations thereof. In some embodiments, the surfactant(s) are non-ionic surfactants. In some embodiments, the surfactant(s) are ionic surfactants. The selection of an appropriate surfactant depends upon the relevant applications and conditions of use, and appropriate surfactants are known to those skilled in the art.

In some embodiments, a pesticidal composition includes a suitable carrier. A suitable carrier can be selected by one skilled in the art, depending on the particular application desired and the conditions of use of the composition. Commonly used carriers include mineral oil, vegetable oil and other inert carriers listed by the EPA as a Minimal Risk Inert Pesticide Ingredients (4A), Inert Pesticide Ingredients (4B) or under EPA regulation 40 CFR 180.950, each of which is hereby incorporated herein in its entirety for all purposes including for example, castor oil.

Some embodiments of the present invention include combinations of a pesticidal natural oil (and/or components and/or derivatives thereof) with a pesticidal natural fungal entomopathogen and one or more other natural oils (plant, animal or mineral derived), synthetic oils, and/or chemical derivatives of any of the foregoing.

In some embodiments, a pesticidal composition comprises a pesticidal natural oil at a concentration of between 5% and 20% by weight, including any concentration therebetween e.g. 5.5%, 7.5%, 10%, 15% and 19% by weight; and a pesticidal natural fungal entomopathogen at a concentration between 1×10⁵ to 1×10¹⁰ spores per ml, including any concentration therebetween e.g. 5×10⁵, 1×10⁶, 5×10⁶, 1×10⁷, 5×10⁷, 1×10⁸, 5×10⁸, 1×10⁹, 5×10⁹ or1×10¹⁰ spores per ml.

In some embodiments, a pesticidal composition is provided in which the weight ratio of a pesticidal natural fungal entomopathogen to pesticidal natural oil is in the range of 0.25:1 to 10:1, including 0.5:1, 1:1, 2:1, 3:1, 4:1, 5:1, 6:1, 7:1, 8:1 or 9:1.

Some embodiments of the present invention can be used to control pests such as arthropods, including insects and arachnids. Some embodiments of the present invention can be used to control insects or arthropods upon which they are expected to be effective based on their demonstrated activity, including, but not limited to, whiteflies, mosquitoes, flies, aphids, silverfish, lice, stink bugs, moths, beetles, lace bugs, green peach aphids, western floral thrips, diamondback moths, leafminers, grasshoppers, crickets, locusts, leafhoppers, planthoppers, psyllids, scale insects, midges, fruit flies, earworms, bollworms, armyworms, budworms, hornworms, milkweed bugs, mealy bugs, weevils, botflies, face flies, sawflies, rice bugs, coffee bugs, vegetable bugs, corn borers, horn flies, blowflies, sowbugs, pillbugs, and centipedes. This disclosure is intended to encompass uses against all of the above, as well as uses against other pests, including other insects and arachnids, and other organisms including fungi, bacteria, viruses, and nematodes.

In some embodiments, the pesticidal compositions described herein are effective to kill and/or control pests and/or prevent eclosion of their eggs, or exhibit improved knockdown of a pest, and/or synergistic pesticidal activity, when the concentration of each of the pesticidal natural oil and the pesticidal natural fungal entomopathogen is below a level at which the pesticidal natural oil and the pesticidal natural fungal entomopathogen used alone would be effective to achieve the same function. In some embodiments, the pesticidal compositions described herein exhibit a synergistic pesticidal effect as compared with the activity the pesticidal natural oil or the pesticidal natural fungal entomopathogen used alone. In some embodiments, the pesticidal compositions described herein exhibit significantly improved pesticidal effect as compared with the activity of the pesticidal natural oil or the pesticidal natural fungal entomopathogen used alone at the same concentration.

Some embodiments of the present invention can be used to control pests that affect plants or agriculture, such as aphids or whiteflies. In some embodiments, any of the compositions described above may be used in any situation in which a neem oil-based insect control agent is currently employed.

In some embodiments, any of the compositions described above are formulated in a deliverable form suited to a particular application. Deliverable forms that can be used in accordance with embodiments of the present invention include, but are not limited to, liquids, emulsions, fumigants, oily dispersions, emulsifiable concentrates and aerosol sprays. Suitable deliverable forms can be selected and formulated by those skilled in the art using methods currently known in the art.

In some embodiments, any of the compositions described herein are applied outdoors or to plants or agricultural areas and/or inside or outside structures.

Some embodiments provide methods of using any of the compositions described above to control populations of whiteflies and/or other insects, arachnids and/or other arthropods. Some embodiments provide a method of killing and/or controlling pests and/or eclosion of their eggs by applying any of the compositions described herein directly to the pests or to surfaces where the pests or their eggs may contact the composition. In some embodiments, the pests are insects and/or arachnids. In some embodiments, the insects are of the orders hemiptera, hymenoptera, blattodea, isopteran, diptera or lepidoptera. In some embodiments, the pests are whiteflies and aphids.

Some embodiments of the present invention can be used in dispersible forms in agricultural or other outdoor settings to control pests.

In some embodiments, the compositions described herein exhibit synergistic pesticidal activity. In one embodiment, pests are killed or controlled, and/or eclosion are prevented by applying any of the compositions described herein directly to the pests or to surfaces where the pests or their eggs may contact or otherwise be exposed to the composition. A period of time greater than about a week, e.g. 5 days, 6 days, 7 days, 8 days, 9 days, 10 days, 11 days, 12 days, 13 days, 14 days or 15 days, or longer is allowed to pass. Then any of the compositions described herein are re-applied to the pests or to surfaces where the pests or their eggs may contact or otherwise be exposed to the composition.

Formulations according to some embodiments can be prepared in any suitable manner. Some embodiments of the present invention provide methods for preparing pesticidal formulations comprising mixing a pesticidal natural oil and/or a component and/or a derivative thereof and a pesticidal natural fungal entomopathogen. The surfactant is added to the carrier oil to which the pesticidal natural oil is added, and then pesticidal natural fungal entomopathogen is added to the liquid phase. Other carriers, surfactants and pesticides, may optionally be added. Appropriate preservatives or stabilizers may optionally be added. Materials that encapsulate, hold, transport, delay release or otherwise improve delivery may optionally be added.

### EXAMPLES

Embodiments of the present invention are further described with reference to the following examples, which are intended to be illustrative and not limiting.

In the examples that follow, the neem oil used was cold pressed neem seed oil (“CP. neem oil”).

### Example 1

### Prevention of Egg Emergence

This example illustrates the prevention of egg emergence by a composition including neem oil, Beauveria bassiana, and an appropriate surfactant. The prevention of egg emergence is compared among different concentrations of neem of the compositions and to an untreated control group. Solutions comprising neem oil at 5, 10, 15 and 20% by weight, 1×10⁹ spores/ml of Beauveria bassiana strain GHA, and 10.0% ethoxylated nonylphenol oil by weight were prepared with mineral oil as a carrier diluent. Whiteflies eggs laid on tomato leafs (each group with 40 eggs) were sprayed directly with 2.5 ml per liter of each solution. Five replicates for each of the Treated Groups, five negative Control Group, and five positive Xpectro Group, were tested concurrently.

At a 15 day interval, the number of hatched and unhatched eggs present were counted and compared to other Treated Groups, the Control Group and Positive Control Group. One egg was counted as “hatched” for every new nymph present.

While the eggs in the Control Group hatched at the predicted interval of approximately 10 to 15 days, eggs in the Treated Groups were significantly impaired by experiment's end 15 days post-treatment. No difference was observed between spray treatments. Table 1 shows the egg emergence data of the treated groups at the stated daily intervals as compared to the Untreated Control.

TABLE 1
Mean % Egg eclosion of white fly (Trialeurodes vaporariorum) eggs
observed 15 days after infestation and treatment application.

| | Mean % Eclosion | | | | | |
|---|---|---|---|---|---|---|
| Days After | Neem | Neem | Neem | Neem | | |
| Application | 5.0% | 10.0% | 15.0% | 20.0% | XPECTRO | CON- |
| (DAA) | w/w | w/w | w/w | w/w | OD | TROL |
| 15 | 8.0 | 11.8 | 11.8 | 12.3 | 9.6 | 94.0 |

### Example 2

### Pesticidal Activity

‘Solutions’ containing neem oil at 5, 10, 15 and 20% by weight, 1×10⁹ spores/ml of Beauveria bassiana strain GHA, and 10.0% ethoxylated nonylphenol oil by weight were prepared with mineral oil as a carrier diluent. A dilution was prepared, comprising 2.5 ml of formulations in water. These were applied by spray to leaf surfaces and target pest. Four replicates of each treatment group and of a negative Control Group were tested concurrently. Mortality was observed at specified intervals after infestation. Target insect, rose aphids (Macrosiphum euphorbiae) were counted dead if they were unresponsive when stimulated.

The percentage of dead aphids was measured at 1, 2, 3, 4, 5, 6, 7 and 8 after treatment and compared against controls. The data collected are summarized in Table 2 and results graphed in FIG. 2. At levels as low as 0.0125% neem oil and 2.5×10⁶ spores/ml of Beauveria bassiana strain GHA the combination demonstrated improved insecticidal activity over an untreated control group.

TABLE 2
Pesticidal Activity.

| | Efficacy(%) | | | | | | | |
|---|---|---|---|---|---|---|---|---|
| | Days after application (DDA) | | | | | | | |
| Treatment | 1 | 2 | 3 | 4 | 5 | 6 | 7 | 8 |
| Neem 5.0% | 48.0 | 49.0 | 50.0 | 62.2 | 68.6 | 75.0 | 80.9 | 87.0 |
| w/w | | | | | | | | |
| Neem 10.0% | 58.0 | 63.0 | 68.0 | 80.6 | 87.1 | 93.8 | 94.7 | 95.7 |
| w/w | | | | | | | | |
| Neem 15.0% | 22.0 | 28.0 | 34.0 | 50.0 | 58.2 | 66.7 | 75.5 | 84.8 |
| w/w | | | | | | | | |
| Neem 20.0% | 32.0 | 42.0 | 52.0 | 65.3 | 72.2 | 79.2 | 81.9 | 84.8 |
| w/w | | | | | | | | |
| XPECTRO OD | 46.0 | 49.0 | 52.0 | 63.3 | 69.1 | 75.0 | 83.0 | 91.3 |
| Untreated | 0.0 | 0.0 | 0.0 | 2.0 | 3.0 | 4.0 | 4.0 | 8.0 |
| Control | | | | | | | | |

### Example 3

### Insecticidal Knockdown Activity

This example illustrates the insecticidal knockdown activity of combinations of neem oil or derivatives thereof with Beauveria bassiana against adult aphids, when compared with knockdown activity of Beauveria bassiana alone. Six solutions were prepared: ‘Solution A’ included 5% neem oil by weight, 1×10⁹ spores per ml Beauveria bassiana, and 10% nonylphenol ethoxylate by weight; ‘Solution B’ included 10% neem oil by weight, 1×10⁹ spores per ml Beauveria bassiana, and 10% nonylphenol ethoxylate by weight; ‘Solution C’ included 15% neem oil by weight, 1×10⁹ spores per ml Beauveria bassiana, and 10% nonylphenol ethoxylate by weight; ‘Solution D’ included 20% neem oil by weight, 1×10⁹ spores per ml Beauveria bassiana, and 10% nonylphenol ethoxylate by weight; ‘Solution E’ included 1×10¹⁰ spores per ml of Beauveria bassiana by weight and 10% nonylphenol ethoxylate by weight; and ‘Solution F’ included 0.75% Pyrethrins by weight, 1×10⁹ spores per ml Beauveria bassiana and 10% nonylphenol ethoxylate by weight. Adult aphids were infested on to lettuce leafs. Aphids were treated by applying a solution containing 2.5 ml per liter of water of each solution. Mortality was assessed at 24 hours after treatment. Aphids were counted dead if unresponsive when stimulated. The percentage of dead adult aphids was calculated and compared to data from all other formulations. Table 3 summarizes mortality data of respective formulations at the stated intervals.

TABLE 3
Insecticidal knockdown

| Treatment | 24 HAT |
|---|---|
| 1 Untreated check | 0.0 ± 0.0 d |
| 2 Neem 5% w/w (A) | 49.5 ± 8.4 b |
| 3 Neem 10% w/w (B) | 58.5 ± 8.8 b |
| 4 Neem 15% w/w (C) | 27.0 ± 12.4 c |
| 5 Neem 20% w/w (D) | 32.0 ± 8.6 c |
| 6 XPECTRO OD (F) | 100.0 ± 0.0 a |
| 7 Beauveria bassiana (E) | 34.5 ± 8.8 c |

### REFERENCES

Ahmed, K S, et al, “Effects of plant oils on oviposition preference and larval survivorship of Callosobruchus chinensis on azuki bean” (1999) 34:4 Applied Entomology and Zoology 547-550.

Ahmad N, et al, “Effects of neem based insecticides on Plutella xylostella (Linn.)” (2012) 34 Crop Protection 18-24.

Al-mazra'awi M S, et al, “Effect of application method on the interaction between Beauveria bassiana and neem tree extract when combined for Thrips tabaci (Thysanoptera: Thripidae) control” (2009) 7:2 Journal of Food, Agriculture & Environment 869-873.

Brachmachari G, “Neem—an omnipotent plant: a retrospection” (2004) 5:4 Chembiochem 408-21.

Choi, W, et al, “Toxicity of Plant Essential Oils to Tetranychus urticae (Acari: Tetranychidae) and Phytoseiulus persimilis (Acari: Phytoseiidae)” (2004) 97:2 Journal of Economic Entomology, 553-558.

Gahukar, R T, “Formulations of neem based products/pesticides” (1996) 20(9) Pestology 44-45.

Gurusubramanian R S, “Bioefficacy of azadirachtin content of neem formulation against three major sucking pests of tea in Sub Himalayan tea plantation of North Bengal, India” (2011) 44:3 Agricultura Tropica Et Subtropica

Halder J, et al,“Compatibility of Neem Oil and Different Entomopathogens for the Management of Major Vegetable Sucking Pests” (2013) 36:1 National Academy Science Letters 19-25.

Hernández M M, et al, “Compatibility of the entomopathogenic fungus Beauveria bassiana with flufenoxuron and azadirachtin against Tetranychus urticae” (2012) 58:4 Exp Appl Acarol 395-405.

Hummelbrunner, A. L. and Isman, M. B., “Acute, sublethal, antifeedant and synergistic effects of monoterpenoid essential oil compounds on the tobacco cut worm (Lepidoptera: Noctuidae)” (2001) 49 J. Agric. Food Chem. 715-720.

Islam T, et al “Influence of neem on susceptibility of Beauveria bassiana and investigation of their combined, efficacy against sweetpotato whitefly, Bemisia tabaci on eggplant” (2010) 98:1 Pesticide Biochemistry and Physiology. 45-49.

Mishra, A K, et al, “Use of neem oil as a mosquito repellent in tribal villages of mandla district, madhya pradesh” (1995) 32:3 Indian J Malariol 99-103.

Mohan, M C, et al, “Growth and insect assays of Beauveria bassiana with neem to test their compatibility and synergism (2007) 17:10 Biocontrol Science and Technology 1059-1069.

Nicoletti M, et al, “Current mosquito-borne disease emergencies in Italy and climate changes. The neem opportunity” (2014) 1:2 Trends Vector Res Parasitol.

Pavela, R., Kazda, J., & Herda, G., “Effectiveness of Neem (azidirachta indica) insecticides against Brassica pod midge (Dasinera brassicae Winn.)” (2009) 82:3 Journal of Pest Science 235.

Romero, A, et al, “Insecticide Resistance in the Bed Bug: A Factor in the Pest's Sudden Resurgence” (2007) 44:2 J Med Entomol 175.

Schumutter, H, “Properties and potential of natural pesticides from the neem tree, Azadirachta indica” (1990) 35 Annu Rev Entomol 271. Chromatogr. A. 225-234.

U.S. Pat. No. 4,556,562 Larson et al.

U.S. Pat. No. 5,472,700 Steatz et al.

U.S. Pat. No. 5,679,662 Chang et al.

U.S. Pat. No. 5,792,465 Hagarty et al.

U.S. Pat. No. 6,703,034 Parmar et al.

Patent WO2013050967A1 Manhas et al.

What is claimed is:

1. A pesticidal composition comprising a pesticidal natural fungal entomopathogen and/or a pesticidal natural oil.

2. A pesticidal composition as defined in claim 1, wherein the pesticidal natural oil and/or component thereof comprises neem.

3. A pesticidal composition as defined in any one of claims 1 to 2, wherein the pesticidal natural oil and/or component thereof comprises neem oil and/or azadirachtin.

4. A pesticidal composition as defined in any one of claims 1 to 3, wherein the pesticidal natural oil comprises any oil having as a major active constituent one or more of azadirachtin, nimbin, nimbinin and salannin.

5. A pesticidal composition as defined in any one of claims 1 to 4, wherein the pesticidal natural oil is a pesticidal natural oil that comprises one or more constituents known to possess insecticidal activity.

6. A pesticidal composition as defined in any of claims 1 to 5, wherein the constituent known to possess insecticidal activity is present at a percentage greater than or equal to 0.1%, 0.5% or 0.75% by weight in the pesticidal natural oil.

7. A pesticidal composition as defined in any one of claims 1 to 6, wherein pesticidal natural fungal entomopathogen selected from a group of: Aschersonia spp. Beauveria spp., Entomophthora spp., Hirsutella spp., Isaria spp., Lecanicillium spp., Metarhizium spp. Nomuraea spp., and Paecilomyces spp.

8. A pesticidal composition as defined in any one of claims 1 to 7, wherein pesticidal natural fungal entomopathogen comprises a Beauveria bassiana strain.

9. A pesticidal composition as defined in any one of claims 1 to 8, wherein pesticidal natural fungal entomopathogen comprises Beauveria bassiana strain GHA.

10. A pesticidal composition as defined in any one of claims 1 to 9, wherein the pesticidal natural oil and/or component and/or derivative thereof comprises neem oil and the pesticidal natural fungal entomopathogen comprises Beauveria bassiana strain GHA.

11. A pesticidal composition as defined in any one of claims 1 to 10, comprising a surfactant.

12. A pesticidal composition as defined in claim 11, wherein the surfactant comprises ethoxylated alcohols, ethoxylated fatty esters, alkoxylated glycols, ethoxylated fatty acids, carboxylated alcohols, carboxylic acids, fatty acids, ethoxylated alkylphenols, fatty esters, sodium dodecylsulfide, other fatty acid-based surfactants, other natural or synthetic surfactants, or a combination thereof.

13. A pesticidal composition as defined in any one of claim 11 or 12, wherein the surfactant is present at a concentration of between 2% and 12% by weight, wherein the surfactant optionally comprises nonylphenol ethoxylate.

14. A pesticidal composition as defined in any one of claims 1 to 13, comprising a carrier, wherein the carrier optionally comprises mineral oil, present at a concentration of between 80% and 95% by weight.

15. A pesticidal composition as defined in claim 14, wherein the carrier comprises a mineral or vegetable oil.

16. A pesticidal composition as defined in any one of claims 1 to 15, wherein the pesticidal natural oil is present at a concentration of between 2% and 20% by weight, including any concentration there between, including 3%, 5%, 10%, 15% or 19% by weight.

17. A pesticidal composition as defined in any one of claims 1 to 16, wherein the pesticidal natural fungal entomopathogen is present at a concentration of between 1×10⁵ and 1×10¹⁰ spores per ml, including any concentration there between, including 1×10⁵ and 1×10¹⁰ spores per ml.

18. A pesticidal composition as defined in any one of claims 1 to 17, wherein the pesticidal natural oil comprises neem oil at a concentration of 5% to 10% by weight, and wherein pesticidal natural fungal entomopathogen at a concentration of 1×10⁹ spores per ml.

19. A pesticidal composition as defined in any one of claims 1 to 18, comprising a surfactant at a concentration of between about 2 to 10% by weight.

20. A pesticidal composition as defined in any one of claims 1 to 19, for use in preventing or eliminating pest infestations.

21. A pesticidal composition as defined in claim 20, wherein the pests comprise arthropods, that comprise insects and/or arachnids.

22. A pesticidal composition as defined in claim 21, wherein the arthropods comprise cockroaches, whiteflies, mosquitoes, flies, aphids, scabies, lice, stink bugs, moths, beetles, lace bugs, green peach aphids, western floral thrips, diamondback moths, leafminers, grasshoppers, crickets, locusts, leafhoppers, planthoppers, psyllids, scale insects, midges, houseflies, fruit flies, earworms, bollworms, armyworms, budworms, hornworms, milkweed bugs, mealy bugs, weevils, botflies, face flies, sawflies, rice bugs, coffee bugs, vegetable bugs, corn borers, horn flies, blowflies, sowbugs, pillbugs, centipedes, silverfish, spiders, ticks, scorpions or mites.

23. A pesticidal composition as defined in any one of claims 20 to 22, wherein the pests are located in greenhouses, outdoors, or on agricultural land.

24. A pesticidal composition as defined in any one of claims 1 to 23, wherein the pesticidal composition is effective to kill and/or control pests and/or prevent or reduce eclosion of their eggs.

25. A pesticidal composition as defined in any one of claims 1 to 24, wherein the pesticidal composition exhibits effective knockdown pesticidal activity, and/or exhibits effective synergistic pesticidal activity.

26. A pesticidal composition as defined in any one of claims 19 to 25, wherein the pesticidal natural oil comprises neem oil and the pesticidal natural fungal entomopathogen comprises Beauveria bassiana.

27. A method of killing or controlling pests comprising applying a composition as defined in any one of claims 1 to 26 directly to the pests or to surfaces where the pests or their eggs may contact or otherwise be exposed to the composition.

28. A method of killing and/or controlling arthropods and/or eclosion of their eggs, comprising applying a composition as defined in any one of claims 1 to 27 directly to the arthropods or to surfaces where the arthropods or their eggs may contact or otherwise be exposed to the composition.

29. A method of preventing eclosion of arthropod eggs comprising applying a composition as defined in any one of claims 1 to 28 to the eggs and/or to a surface where arthropods may deposit their eggs.

30. A method of killing or controlling pests or arthropods and/or eclosion of their eggs as defined in any one of claims 27 to 29 comprising applying a composition as defined in any one of claims 1 to 29 directly to the pests or arthropods, or to surfaces where the pests or arthropods or their eggs may contact or otherwise be exposed to the composition, waiting at least 5 days, 6 days, 7 days, 8 days, 9 days, 10 days, 11 days, 12 days, 13 days, 14 days or 15 days and then re-applying a composition as defined in any one of claims 1 to 40 directly to the pests or arthropods, or to surfaces where the pests or arthropods or their eggs may contact or otherwise be exposed to the composition.

31. A method as defined in any one of claim 27 or 30, wherein the pests comprise cockroaches, whiteflies, mosquitoes, flies, aphids, scabies, lice, stink bugs, moths, beetles, lace bugs, green peach aphids, western floral thrips, diamondback moths, leafminers, grasshoppers, crickets, locusts, leafhoppers, planthoppers, psyllids, scale insects, midges, houseflies, fruit flies, earworms, bollworms, armyworms, budworms, hornworms, milkweed bugs, mealy bugs, weevils, botflies, face flies, sawflies, rice bugs, coffee bugs, vegetable bugs, corn borers, horn flies, blowflies, sowbugs, pillbugs, centipedes, silverfish, spiders, ticks, scorpions or mites.

32. A method as defined in any one of claims 27 to 30, comprising applying the composition to plants and/or parts of plants and/or the soil surrounding plants.

33. A method for preparing an insecticidal composition, comprising mixing a pesticidal natural oil and/or a component and/or a derivative thereof and a pesticidal natural fungal entomopathogen.

34. A method for preparing an insecticidal composition comprising a pesticidal natural oil and/or component and/or derivative thereof and adding a pesticidal natural fungal entomopathogen to the pesticidal natural oil and/or component and/or derivative thereof.

35. A method as defined in any one of claim 33 or 34, comprising adding a surfactant.

36. A method as defined in claim 35, wherein adding the surfactant comprises adding ethoxylated alcohols, ethoxylated fatty esters, alkoxylated glycols, ethoxylated fatty acids, carboxylated alcohols, carboxylic acids, fatty acids, ethoxylated alkylphenols, fatty esters, sodium dodecylsulfide, other fatty acid-based surfactants, other natural or synthetic surfactants, or a combination thereof.

37. A method as defined in either one of claim 35 or 36, wherein adding a surfactant comprises adding the surfactant to a final concentration of between 2% and 12% by weight.

38. A method as defined in any one of claims 33 to 37, comprising adding a carrier diluent.

39. A method as defined in claim 38, wherein adding the carrier diluent comprises an oil to a final concentration of between 80% and 95% by weight.

40. Any new and inventive composition or method described or illustrated herein, or reasonably inferred from this disclosure.
